(19) United States
(12) Patent Application Publication
(10) Pub. No.: US 2007/0278374 A1
(43) Pub. Date: Dec. 6, 2007

(54) Route mark-out stake

(76) Inventor: Walter Signori, Albino (BG) (IT)

Correspondence Address: LADAS & PARRY, 5670 WILSHIRE BOULEVARD, SUITE 2100, LOS ANGELES, CA, 90036-5679, US

(21) Appl. No.: 11/714,720

(22) Filed: Mar. 5, 2007

(30) Foreign Application Priority Data
Mar. 6, 2006 (IT) MI2006U 000078

(51) Int. Cl. F16M 13/00

(52) U.S. Cl. 248/545; 248/530

(57) ABSTRACT

The route (3) mark-out stake (1) comprises a fixing portion (5) insertable into the ground and a tape support portion (6). The fixing portion (5) is made of material more rigid than that of the support portion (6).

The present invention relates to a route mark-out stake (for use with or without tape); particular reference will be made hereinafter to stakes used to mark out sporting and other routes such as, for example, routes of motorcycle tracks (motorcross, etc.).

When obligatory routes such as those of a motorcycle circuit are to be marked out, one-piece wooden stakes are used driven into the ground, with a portion projecting from the ground.

Tapes are sometimes fixed to the projecting portion of the stake to define the route (or circuit).

However during competitions, athletes and in particular motorcyclists tend to take those trajectories which enable them to maintain maximum speed or to best prepare for subsequent bends or obstacles; for this reason they tend to always pass close to the stakes.

In passing close to the stakes, the athletes often strike against them so that the struck stake breaks or is extracted or uprooted from the ground.

In this situation the circuit route is no longer defined with certainty; this situation is therefore to be avoided.

Moreover, such impacts can also damage the motor vehicle, the safety of the driver then being endangered by the stake in the case of a fall.

The aim of the present invention is therefore to provide a route mark-out stake by which the stated drawbacks of the known art are eliminated.

Within the scope of this aim, an object of the invention is to provide a stake which, when struck by an athlete or by his motorcycle during a race, does not become uprooted, but remains properly driven into the ground.

Another object of the invention is to provide a stake which, when struck, limits the risk of damage to the motor vehicle and danger to driver safety.

The stated aim, together with these and further objects, are attained according to the present invention by providing a stake in accordance with the accompanying claims.

Further characteristics and advantages of the invention will be more evident from the description of a preferred but non-exclusive embodiment of the stake according to the invention, illustrated by way of non-limiting example in the accompanying figures, in which:

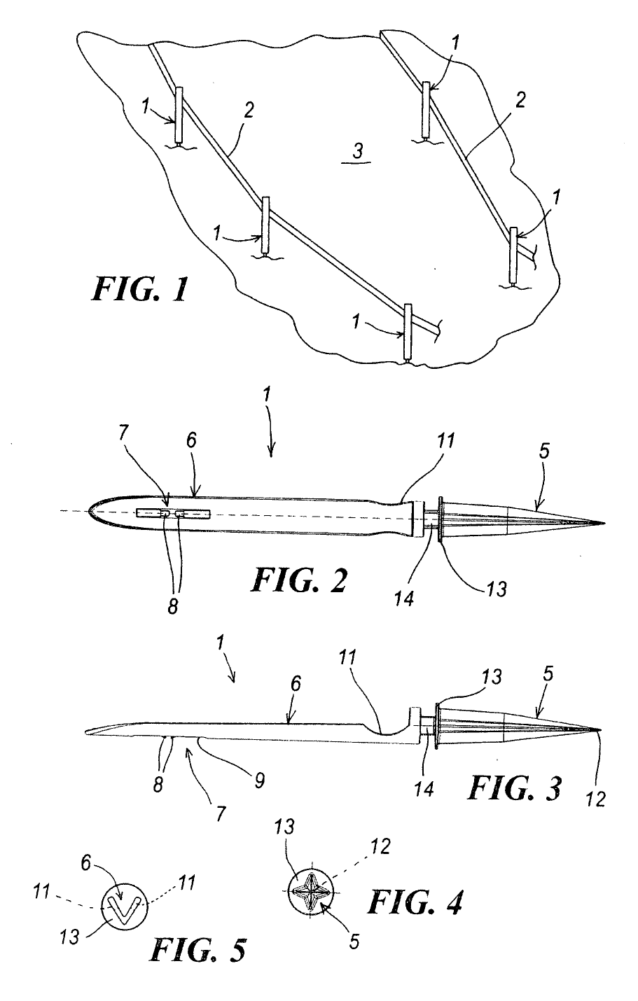

FIG. 1 is a view of a portion of a route defined by the stakes of the invention;

FIG. 2 is a side elevation view of the stake of the invention;

FIG. 3 is a view of the stake of FIG. 1 rotated through 90 degrees;

FIG. 4 is a front elevation view (taken at the portion to be inserted into the ground) of the stake of FIG. 1; and

FIG. 5 is a front elevation view (taken at the portion to remain outside the ground) of the stake of FIG. 1.

With reference to said figures, these show a route mark-out stake, indicated overall by the reference numeral 1.

FIG. 1 shows a plurality of stakes 1 of the invention supporting a pair of tapes 2 to define a route 3 of a circuit.

The stake 1 comprises a fixing portion 5 insertable into the ground and an elongate support portion 6 for the tape 2.

Advantageously, the fixing portion 5 is made of a more rigid material than the support portion 6 so that impact by a motorcycle causes the support portion to bend without the fixing portion being extracted from the ground, so limiting risk to the motorcycle and driver.

The support portion 6 carries, for the tape 2, retention means 7 defined by a pair of hooks 8 for perforating and retaining the tape 2.

The retention means 7 also comprise a recessed seat 9, the hooks 8 projecting into the recessed seat 9.

At its base the support element 6 presents a bending inducement 11 comprising at least one recess in the support element 6.

The support element 6 is of V cross-section, the recesses 11 being provided in the two free edges of the V cross-section.

The fixing portion 5 is pointed at 12 and is bounded at the connection to the support portion 6 by a disc 13.

Advantageously, a small block 14 is interposed between the fixing portion 5 and the support element 6 to facilitate extraction of the stake 1 from the ground by a suitable tool.

This block 14 is made of the same material as the fixing portion 5.

In a preferred embodiment, the support portion 6 and the fixing portion 5 are made by co-moulding two different plastic materials presenting different mechanical characteristics.

For example, the fixing portion 5 of the stake 1 is made of POLYAMIDE, for example the product Radilon USZ 200 produced by the Radici Company, whereas its support portion 6 is made of POLYPROPYLENE, for example the product Moplen EP 300 L produced by the Basel Company.

The operation of the stake of the invention is apparent from that described and illustrated, and is substantially as follows.

The route 3 is initially marked out by the stakes 1 with or without the tapes 2.

During a competition, when a motorcyclist strikes a stake 1, it bends because of the presence of the recesses 11 and by virtue of the characteristics of the materials, without the fixing portion 5 becoming uprooted and with only small risk to the driver and motorcycle.

It has been found in practice that the stake of the invention enables circuits to be marked out which are able to maintain their shape unaltered for the entire duration of a sporting or non-sporting event, or circuits which can be quickly and effectively re-established.

In practice the materials used and the dimensions can be chosen at will according to requirements and to the state of the art.

1. A route mark-out stake comprising a fixing portion insertable into the ground and a tape support portion, characterised in that the fixing portion is made of material more rigid than that of the support portion.

2. A stake as claimed in claim 1, characterized in that the support portion carries tape retention means.

3. A stake as claimed in claim 2, characterized in that said tape retention means are defined by at least one hook able to retain the tape.

4. A stake as claimed in claim 3, characterised in that said retention means also comprise a recessed seat, said at least one hook projecting into said recessed seat.

5. A stake as claimed in claim 1, characterised in that the support element presents a bending inducement at its base.

6. A stake as claimed in claim 5, characterised in that the bending inducement comprises at least one recess in said support element.

7. A stake as claimed in claim 6, characterised in that the support element presents a V cross-section, the recesses being provided in the two free edges of the V cross-section,

8. A stake as claimed in claim 1, characterized in that the fixing portion is pointed and is bounded at the connection to the support portion by a disc.

9. A stake as claimed in claim 1, characterised by a block interposed between the support portion and fixing portion to facilitate its removal from the ground.

10. A stake as claimed in claim 9, characterised in that said block is made of the same material as the fixing portion.

11. A stake as claimed in claim 1, characterised in that said support portion and said fixing portion are produced by co-moulding two different plastic materials.
